(19) United States
(12) Patent Application Publication
(10) Pub. No.: US 2016/0003046 A1
(43) Pub. Date: Jan. 7, 2016

(54) Parallel Twin-Impeller Compressor Having Swirl-Imparting Device For One Impeller

(71) Applicant: Honeywell International Inc., Morristown, NJ (US)

(72) Inventors: William Joseph Smith, Gardena, CA (US); Vai Man Lei, Torrance, CA (US); James Reyenga, Long Beach, CA (US)

(21) Appl. No.: 14/323,092

(22) Filed: Jul. 3, 2014

(51) Int. Cl. F01D 1/06; F04D 27/00; F04D 29/42; F04D 29/44; F04D 17/10; F04D 25/16

(52) U.S. Cl. CPC F01D 1/06; F04D 17/10; F04D 25/16; F04D 29/4213; F04D 29/444; F04D 27/009; F05D 2220/40

(57) ABSTRACT

An turbocharger includes a parallel twin-impeller compressor and separate inlets into the two impellers. A first or outboard impeller receives one stream of inlet air and a second or inboard impeller receives its own separate stream of inlet air by way of a generally annular inlet volute surrounding the inlet to the second impeller. Air is fed from the inlet volute radially inwardly through a feed passage to the inlet to the second impeller. A plurality of inlet guide vanes are located in the feed passage for the second impeller, the inlet guide vanes creating a swirling air stream into the second impeller. Introduction of swirl to the second impeller alters the flow distribution between the impellers and affects the stability of the overall stage.

### BACKGROUND

The present disclosure relates to turbochargers and to compressors used in turbochargers, and particularly relates to parallel twin-impeller compressors for turbochargers.

As turbocharged engine power densities continue to increase, they challenge the turbocharger compressor's ability to provide sufficient map width to satisfy the engine's airflow needs. This challenge is further exacerbated when LPL EGR (Low Pressure Loop Exhaust Gas Recirculation) is employed because LPL EGR adds additional flow requirements to the compressor for a given power level. Compressor map-width limitations are sometimes addressed by using multi-turbo arrangements, which offer performance improvements, but at the expense of increased cost, lower durability, and greater packaging size for the engine manufacturer. There is thus a need for technologies that can expand the operable and useful map width of a compressor in a single turbocharger.

A device that swirls the inlet air into a centrifugal compressor fundamentally changes the operating conditions of the compressor and thus its characteristic behavior. Swirl in the same direction as the rotation of the wheel is known as pre-swirl. Pre-swirl reduces the blade incidence angle, unloads the inducer, and thus allows the compressor stage to operate stably at a lower mass flow rate (i.e., the surge line moves toward a lower flow rate). This results in an increase in surge margin and total operable range.

Swirl in the opposite direction to the wheel rotation is known as counter-swirl. Counter-swirl tends to increase the blade incidence angle and blade loading, and to increase the compressor pressure ratio at a given compressor speed and flow rate.

### BRIEF SUMMARY OF THE DISCLOSURE

The present disclosure concerns compressors having two impellers in a fluidly parallel arrangement. Because the two impellers in a parallel twin-impeller compressor interact with each other, introducing pre-swirl or counter-swirl to one impeller results in a stabilizing mechanism different from that achieved when pre- or counter-swirl is used in a single-impeller compressor. Introduction of pre- or counter-swirl to one impeller alters the flow distribution between the impellers and affects the stability of the overall stage. The two impellers can be of different designs and the introduced swirl can help optimize the compressor performance for different applications. There is a unique opportunity to utilize this strategy to realize a significant map width enhancement for a twin-impeller compressor.

The present disclosure describes embodiments of turbochargers having a parallel twin-impeller compressor. In one embodiment, a turbocharger is described having a turbine housing and a turbine wheel disposed in the turbine housing, the turbine wheel being mounted on one end of a rotatable shaft, the turbine housing receiving exhaust gas and feeding the exhaust gas through the turbine wheel to rotatably drive the turbine wheel and the shaft.

The turbocharger further comprises a compressor housing and a twin-impeller compressor wheel disposed in the compressor housing. The twin-impeller compressor wheel is mounted on an opposite end of the shaft and has a first (or outboard) impeller and a second (or inboard) impeller. A center housing contains bearings for the shaft, the center housing being disposed between the compressor housing and the turbine housing.

The compressor housing defines a generally annular discharge volute surrounding the twin-impeller compressor wheel, and there is a common diffuser passage through which air compressed by each of the first and second impellers is led into the discharge volute. The compressor housing also defines a first inlet for leading a first stream of air into the first impeller along a direction generally axially toward the turbine wheel.

The turbocharger further includes a second inlet for leading a second stream of air into the second (inboard) impeller along a direction generally axially away from the turbine wheel. There is a generally annular inlet volute for receiving the second air stream, and a feed passage circumferentially surrounding the second inlet. The feed passage feeds the second air stream from the inlet volute generally radially inwardly to the second inlet.

A plurality of inlet guide vanes are located upstream of the second impeller. The inlet guide vanes can be immovable or can be movable for varying their setting angles. The inlet guide vanes create a swirling air stream into the second impeller. The first impeller can receive a substantially non-swirling air stream, although in some situations it may be desirable to introduce pre- or counter-swirl into it.

In one embodiment, the inlet guide vanes are configured for imparting pre-swirl to the swirling air stream entering the second impeller.

In another embodiment, the inlet guide vanes are configured for imparting counter-swirl to the swirling air stream.

In a particular embodiment described herein, the inlet guide vanes are located in the feed passage coming out of the inlet volute for the second impeller, and they impart pre-swirl in the second air stream before it enters the second impeller.

In another particular embodiment described herein, the inlet guide vanes are located in the feed passage for the second impeller and impart counter-swirl in the second air stream.

In accordance with one embodiment, the compressor includes a recirculation system for the first impeller, and the inlet guide vanes are arranged for creating the swirling air stream into the second impeller. The recirculation system in one embodiment comprises a bleed port, a recirculation passage, and an injection port, the bleed port being arranged for bleeding off a portion of the air stream passing through the first impeller, the recirculation passage then conducting said portion to the injection port, which injects said portion into the first air stream upstream of the first impeller.

### BRIEF DESCRIPTION OF THE SEVERAL VIEWS OF THE DRAWING(S)

Having thus described the present disclosure in general terms, reference will now be made to the accompanying drawings, which are not necessarily drawn to scale, and wherein:

FIG. 1 is a perspective view of a turbocharger in accordance with an embodiment of the invention, with a portion of the compressor's inlet volute removed to show internal details;

FIG. 2 is a front view of the turbocharger of FIG. 1, with a portion of the compressor's inlet volute removed to show internal details;

FIG. 3 is an axial cross-sectional view of the turbocharger, along line 3-3 in FIG. 2;

FIG. 4 is a view similar to FIG. 1, showing another embodiment of the invention;

FIG. 5 is a front view of the turbocharger of FIG. 4, with a portion of the compressor's inlet volute removed to show internal details.

### DETAILED DESCRIPTION OF THE DRAWINGS

The present invention now will be described more fully hereinafter with reference to the accompanying drawings in which some but not all embodiments of the invention are shown. Indeed, aspects of the invention may be embodied in many different forms and should not be construed as limited to the embodiments set forth herein; rather, these embodiments are provided so that this disclosure will satisfy applicable legal requirements. Like numbers refer to like elements throughout.

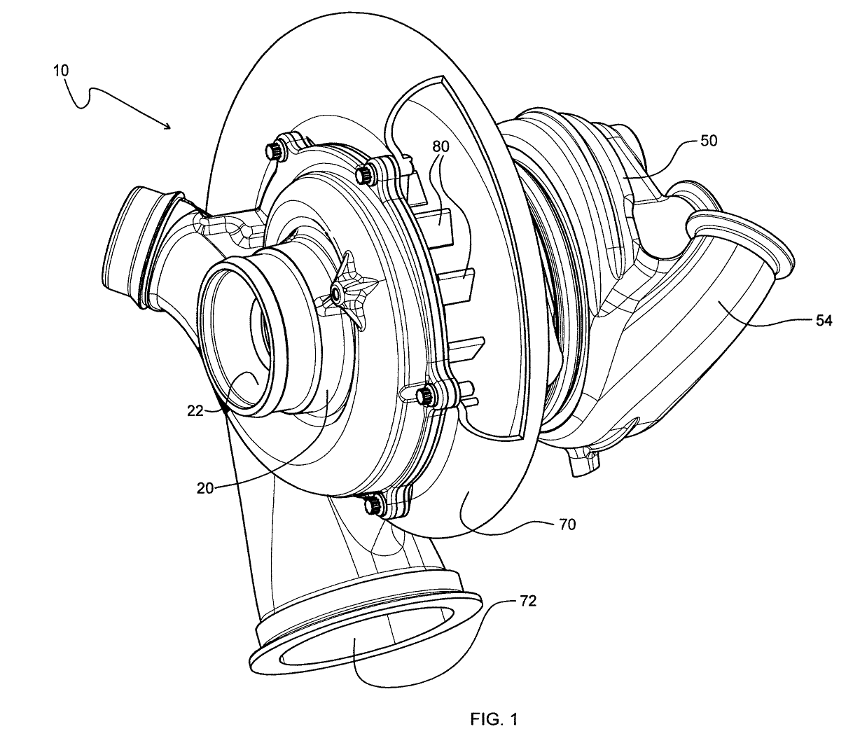

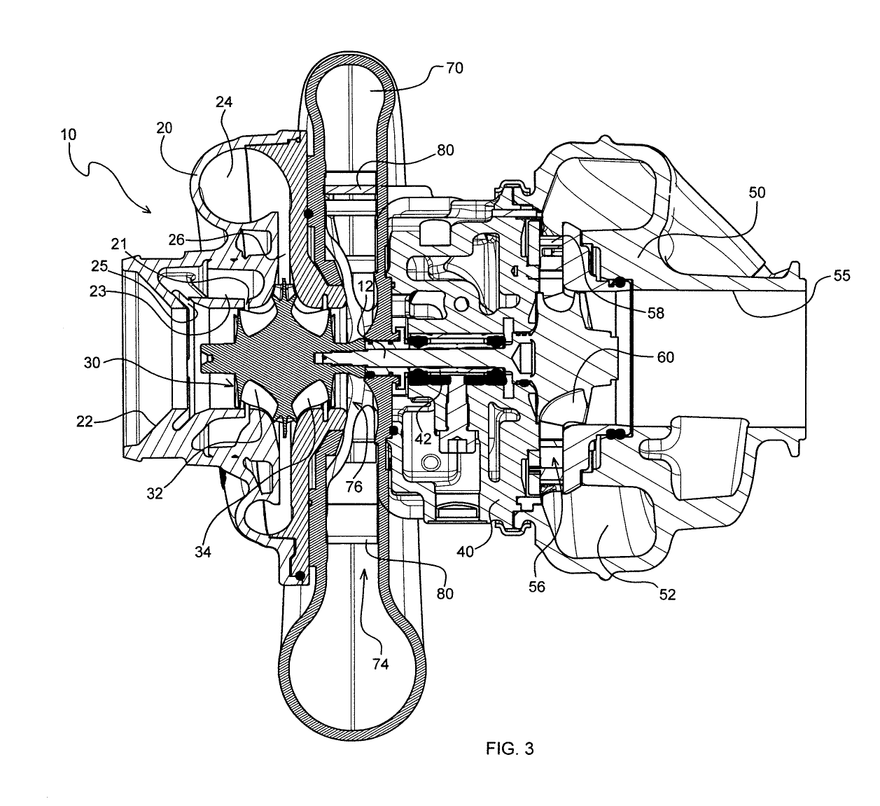

FIGS. 1 through 3 illustrate an exemplary embodiment of a turbocharger 10 in accordance with one embodiment of the invention. With primary reference to FIG. 3, the turbocharger 10 comprises a compressor housing 20 that contains a compressor wheel 30. The compressor wheel is a twin-impeller wheel, having a first impeller 32 and a second impeller 34 mounted one after the other on a rotatable shaft 12. The compressor housing 20 defines a first inlet 22 comprising a generally tubular duct that extends substantially coaxially with the rotation axis of the shaft 12. The first inlet 22 leads air along a substantially axial direction into the first impeller 32. The compressor housing defines a generally annular discharge volute 24 that receives the compressed air coming from the compressor wheel 30. A diffuser 26 leads the compressed air from the wheel exit into the discharge volute 24.

The compressor housing also defines a passive recirculation system for the first impeller 32, comprising a bleed port 21 defined in the shroud of the first impeller in the region of its inducer, a recirculation passage 23 connected to the bleed port 21, and an injection port 25 defined in the first inlet 22 at a location spaced upstream of the first impeller. Under certain operating conditions a portion of the air being compressed in the first impeller 32 can flow through the bleed port 21 into the recirculation passage 23 and then be injected through the injection port 25 back into the main air stream approaching the first impeller.

The turbocharger 12 further comprises a center housing 40 that contains, among other things, a set of bearings 42 for the rotatable shaft 12 passing through an axial bore defined in the center housing.

The turbocharger also includes a turbine housing 50 that contains a turbine wheel 60. The turbine wheel 60 is mounted on the opposite end of the shaft 12 from the twin-impeller compressor wheel 30. The turbine housing defines a generally annular volute 52 that receives exhaust gas from an internal combustion engine via an exhaust gas inlet 54 (FIG. 1). A turbine nozzle 56 leads the exhaust gas from the volute 52 radially inwardly to the turbine wheel 60. The turbine nozzle includes an array of vanes 58 that regulate the flow of exhaust gas into the turbine wheel. The turbine housing defines an axial bore 55 through which exhaust gas that has already passed through the turbine wheel is discharged from the turbine housing.

The present disclosure particularly concerns the way in which air is fed into the second impeller 34 of the compressor wheel 30. The two impellers 32, 34 are in a parallel arrangement, meaning that each of them receives its own separate air stream, the two streams being simultaneously compressed in the respective impellers and being discharged through the common diffuser 26 into the discharge volute 24. As already noted, the first impeller 32 receives a first air stream from the first inlet 22. The second impeller 34 receives a second air stream via a generally annular inlet volute 70. Air is led into the inlet volute 70 via an inlet duct 72. The volute 70 and inlet duct 72 in the illustrated embodiment are formed by a component that is separate and distinct from the compressor housing 20. This component also forms a feed passage 74 that circumferentially surrounds the entrance to the second impeller 34 and leads from the inlet volute 70 radially inwardly to a second inlet 76 for the second impeller.

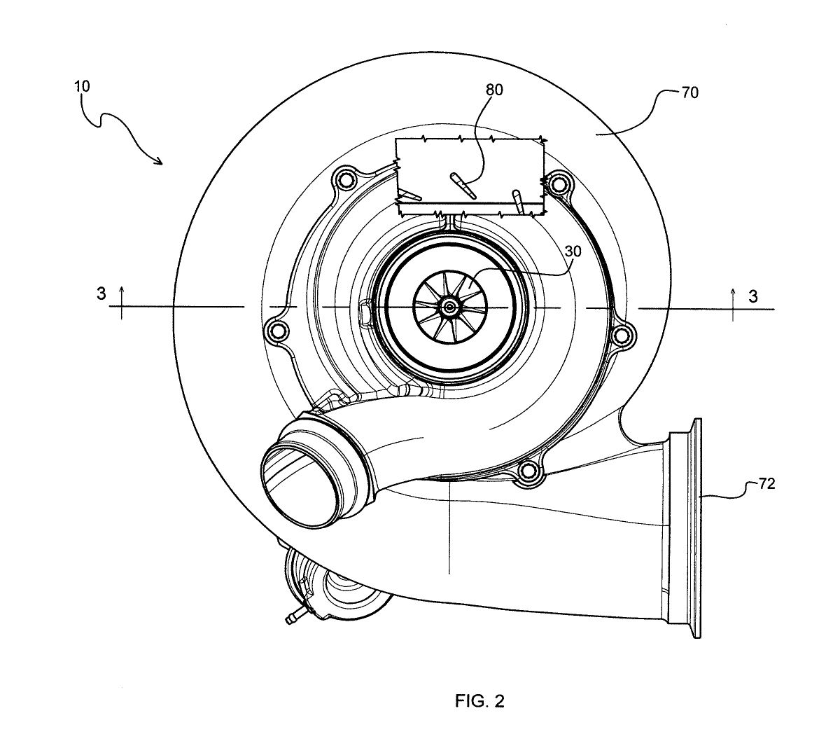

In accordance with this embodiment of the invention, a plurality of inlet guide vanes 80 are disposed in the feed passage 74 for the second impeller 34. In the illustrated embodiment, the inlet guide vanes 80 are immovable. Alternatively they could be movable for varying their setting angles. The inlet guide vanes are configured to impart non-zero swirl in the second air stream before it enters the second impeller. Specifically, the vanes 80 impart pre-swirl to the air stream. Pre-swirl is swirl in the same direction as the rotation direction of the second impeller. Thus, with reference to FIG. 2, the compressor wheel 30 rotates in a clockwise direction, and the inlet guide vanes 80 similarly impart a clockwise pre-swirl to the second air stream before it enters the second impeller. The pre-swirl of the second air stream has the effect of generally reducing the incidence angles of the second impeller blades, unloading the inducers of the blades and thus allowing the second impeller to operate stably at a lower mass flow rate (i.e., the surge line for the second impeller moves toward a lower flow rate). Additionally, there is an interaction effect between the two impellers. The increased flow resistance into the impeller having the inlet guide vanes (in this embodiment, the second impeller 34) will bias a larger percentage of mass flow though the unaltered impeller (in this case, the first impeller 32), thus allowing it to continue to operate stably as total compressor mass flow is reduced. This of course implies that the total air supply originates in a single common inlet conduit (not shown) that branches into two separate conduits, one feeding air into the first inlet 22 for the first impeller and the other feeding air into the inlet duct 72 for the second impeller.

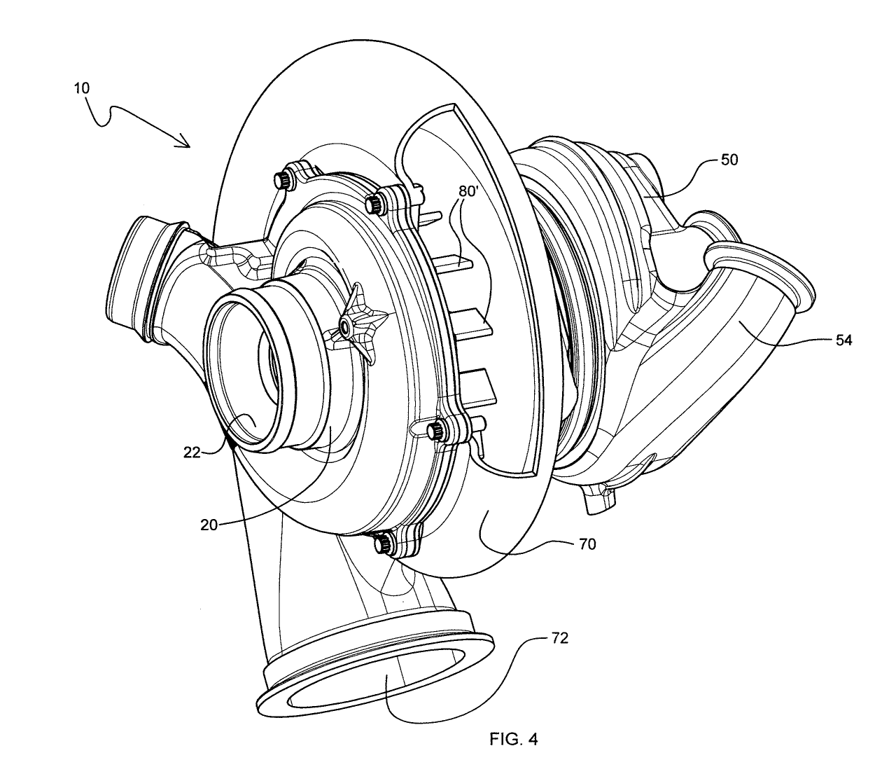

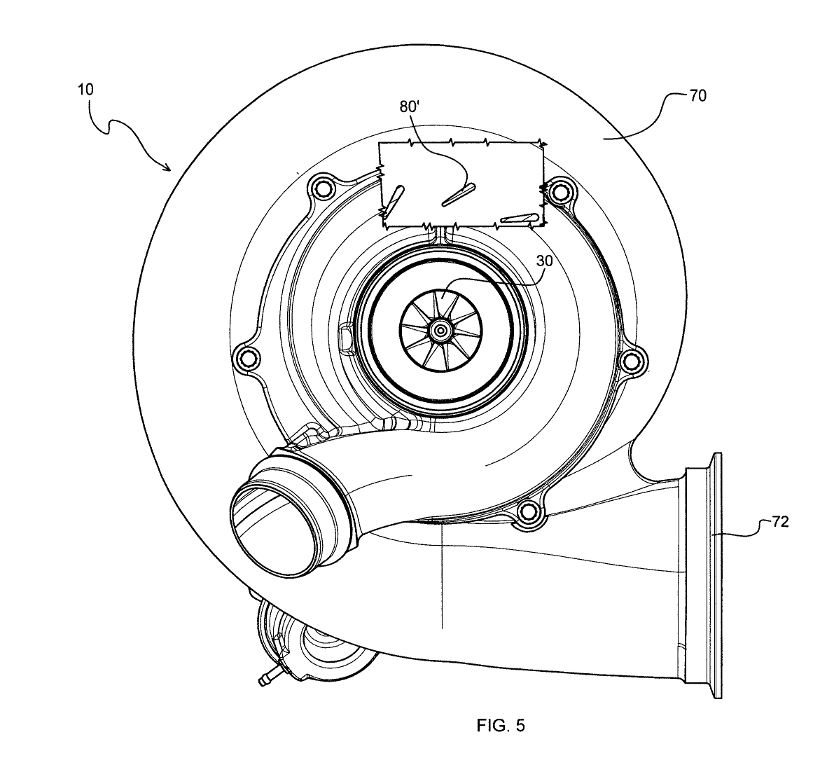

Another embodiment of the invention is illustrated in FIGS. 4 and 5. This embodiment is generally similar to the previously described embodiment, except that the inlet guide vanes 80′ in the current embodiment impart counter-swirl to the second air stream. Thus, with reference to FIG. 5, the compressor wheel 30 rotates clockwise and the vanes 80′ impart counterclockwise counter-swirl to the air stream before it enters the second impeller. Counter-swirl generally increases the incidence angles of the impeller blades, which would usually impair stability, but counter-swirl can be useful when the impeller has a ported shroud (not shown), as it can drive more recirculation. Counter-swirl can also help increase the pressure ratio under certain operating conditions when turbocharger rotational speed is limited.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A turbocharger comprising:
a turbine housing and a turbine wheel disposed in the turbine housing, the turbine wheel being mounted on one end of a rotatable shaft, the turbine housing receiving exhaust gas and feeding the exhaust gas through the turbine wheel to rotatably drive the turbine wheel and the shaft;
a compressor housing and a twin-impeller compressor wheel disposed in the compressor housing, the twin-impeller compressor wheel being mounted on an opposite end of the shaft, the twin-impeller compressor wheel having a first impeller and a second impeller;
a center housing containing bearings for the shaft, the center housing being disposed between the compressor housing and the turbine housing;
the compressor housing defining a generally annular discharge volute surrounding the twin-impeller compressor wheel, there being a common diffuser passage through which air compressed by each of the first and second impellers is led into the discharge volute, and defining a first inlet for leading a first stream of air into the first impeller along a direction generally axially toward the turbine wheel;
the turbocharger further including a second inlet for leading a second stream of air into the second impeller along a direction generally axially away from the turbine wheel, a generally annular inlet volute for receiving the second air stream, and a feed passage circumferentially surrounding the second inlet, the feed passage feeding the second air stream from the inlet volute generally radially inwardly to the second inlet; and
a plurality of inlet guide vanes disposed in and circumferentially spaced about the feed passage coming out of the inlet volute, the inlet guide vanes creating a swirling air stream into the second impeller.

2. The turbocharger of claim 1, wherein the inlet guide vanes are spaced radially outwardly from an entrance into the second inlet.

3. The turbocharger of claim 1, wherein the inlet guide vanes are configured to impart pre-swirl to the swirling air stream.

4. The turbocharger of claim 1, wherein the inlet guide vanes are configured to impart counter-swirl to the swirling air stream.

5. The turbocharger of claim 1, wherein the compressor includes a recirculation system for the first impeller.

6. The turbocharger of claim 5, wherein the recirculation system comprises a bleed port, a recirculation passage, and an injection port, the bleed port being arranged for bleeding off a portion of the air stream passing through the first impeller, the recirculation passage then conducting said portion to the injection port, which injects said portion into the first air stream upstream of the first impeller.
